(19) United States
(12) Patent Application Publication
(10) Pub. No.: US 2016/0296392 A1
(43) Pub. Date: Oct. 13, 2016

(54) SEAT

(71) Applicant: R82 A/S, Gedved (DK)

(72) Inventors: Flemming MOLLER, Horsens (DK); Knud JORGENSEN, Odder (DK)

(21) Appl. No.: 14/783,743

(22) PCT Filed: Apr. 9, 2014
(86) PCT No.: PCT/DK2014/050084

§ 371 Date: Oct. 9, 2015

(30) Foreign Application Priority Data
Apr. 10, 2013 (DK) PA 2013 70197

(51) Int. Cl. A61G 5/10; A47C 7/44

(52) U.S. Cl. CPC A61G 5/1067; A61G 5/10; A47C 7/446

(57) ABSTRACT

An exemplary seat having seat connection mechanism for attaching the seat to a wheelchair includes a seat frame and a backrest. The backrest is pivotably connected to the seat frame through a pivoting mechanism. The seat further includes a biasing member connected to the backrest at a first connection point and a second connection point near the seat frame. The second connection point and the pivoting mechanism are spaced apart from one another by a distance C. The seat further includes an adjustment mechanism adapted for changing the distance C. The second connection point may be connected to a guide arm, such that the position of the second connection point is adjustable by sliding the second connection point along the guide arm, thus making the distance C adjustable.

### FIELD OF THE INVENTION

The present invention relates to seats for wheelchairs and a wheelchair with such a seat.

### BACKGROUND OF THE INVENTION

For the comfort of disabled persons in wheelchairs it is advantageous to equip the wheelchair with a seat having a dynamic reclinable backrest that is capable of absorbing the energy of sudden and forceful voluntary or involuntary movements of the person against the backrest.

The backrest shall also for therapeutic reasons be resilient such that users with a tendency to spasms, sudden uncontrolled movements etc. are not injured when using a wheelchair.

Such a movement will tend to extend the backrest towards a more reclined position. After the energy is absorbed the backrest should be capable of returning the person to an upright sitting position.

Such a wheelchair seat is made available by the applicant with a product known as the “x:panda™”. The seat in the wheelchair is equipped with a reclinable backrest having a gas spring operably positioned between the backrest and the seat for absorbing the energy of the previously described movements extending the backrest.

A seat/backrest construction incorporating a gas spring is known from U.S. Pat. No. 2,018,825. The gas spring is arranged in a fixed (but selectable) position, and serves to provide added comfort to a user.

In order to cater for persons of various weight and strength the gas spring is selected from a range of gas springs each with a fixed rating. In case of a disabled child who is still growing the gas spring may have to be replaced frequently during the life of the wheelchair, because the forces applied to the backrest increases as the weight and height of the child increase. Therefore a certain size of gas spring (a certain tension) will only be optimally suited for the seat for a limited period of time.

### OBJECT OF THE INVENTION

An object of the present invention is to provide a seat for a wheelchair that is suited for disabled children who are still growing.

### DESCRIPTION OF THE INVENTION

According to the present invention this is achieved by a seat having seat connection means for attachment of the seat to a wheelchair comprising a seat frame, a backrest, wherein the backrest is pivotably connected to the seat frame through a pivoting means, and a spring means connected to the backrest at a first connection point and to a second connection point near the seat frame. The second connection point and the pivoting means are spaced by the distance C and the seat comprises adjustment means (113) adapted for changing the distance C.

Thereby the tension of the spring means can be easily adjusted and the seat can thereby be adapted to different weight and strength. It is thereby not necessary to replace the spring with a spring having a different tension.

In an embodiment the adjustment means are adapted for changing the distance C by displacement of the position of said second connection point position. Thereby an adjustment mechanism can be added to one connection point, making the adjustment mechanism simple to implement and handle.

In an embodiment the second connection point is connected to a guide arm and the position of said second connection point and thereby the distance C is adjustable by sliding said connection point along said guide arm. The guide ensures that the second connection point is fixed in all other directions than the relevant adjustment direction during adjustment, whereby the adjustment is easier to handle.

In an embodiment the guide arm is mounted to the seat frame and said second connection point is slidably connected around said guide arm for sliding along said guide arm. This has proven to be a very simple and effective solution.

In an embodiment the guide arm is extending in a direction substantially perpendicular to the direction of the spring means. Thereby the tension is especially easy to adjust.

In an embodiment the seat comprises spring means connected to the backrest and the seat frame and positioned at each side of the seat. Thereby the spring means can absorb energy of movement of backrest evenly along the backrest surface.

In an embodiment the seat comprises a visual indicator for indicating actual distance C between said connection points. Thereby specific settings can be used as references, e.g. when setting according to a previous setting or when setting each side with a similar tension.

In an embodiment the seat comprises locking means for locking the distance C and thereby the second connection point at predefined positions. Thereby it can be ensured that exact same positions are chosen each time when adjusting.

The invention is also directed to a method of adjusting the resiliency of a backrest of a seat for a wheelchair, where said seat has seat connection means for attachment of the seat to a wheelchair comprising;

a seat frame (101),
a backrest (103), wherein the backrest is pivotably connected to the seat frame through a pivoting means (105), and
a spring means (107,207) connected to the backrest at a first connection point (109) and to a second connection point (111) near the seat frame, wherein the second connection point (111) and the pivoting means (105) can be spaced a distance C, where the seat comprises adjustment means (113) adapted for changing the distance C wherein said second connection point (111,211) is connected to a guide arm (115,215) and the position of said second connection point (111,211) and thereby the distance C is adjustable by sliding said second connection point (111,211) along said guide arm (115,215) such that the greater the distance C the softer the resulting spring action will be, and the shorter the distance C the firmer the resulting spring action will be.

The resiliency is the ability of the back rest to be moved by the user during a sudden movement. The spring will dampen this movement. By being able to adjust the attachment point on the guide arm, the basic “force multiplied by the distance equals the resulting force” is utilised in order to adjust the most desirable resiliency (i.e. resilient counterforce) desired for a given user. The adjustment possibility facilitates the adjustment of this force as the need for more or less force is required/desired.

By further providing the spring means as a double acting gas spring member, where said gas spring may be exchanged for another gas spring member having a different spring characteristic, a much wider range of users may be suitable for using the seat/wheelchair, simply by selecting an appropriate gas spring.

The present invention further relates to a wheelchair comprising a seat according to the above and with advantages as described above.

### DESCRIPTION OF THE DRAWING

The invention will be explained in more detail below with reference to the accompanying drawing, where:

FIG. 1 A-D illustrate the principles of the present invention,

FIG. 2 illustrates an embodiment of the present invention, seen from behind the backrest, being in a first angular position relative to the seat frame,

FIG. 3 illustrates an embodiment of the present invention, seen from behind the backrest being in a second angular position relative to the seat frame,

FIG. 4 illustrates an embodiment of the present invention, seen from the side where the second connection point has a first distance C to the pivoting means and where the backrest is in a first angular position relative to the seat frame,

FIG. 5 illustrates an embodiment of the present invention, seen from the side where the second connection point has a first distance C to the pivoting means and where the backrest is in a second angular position relative to the seat frame,

FIG. 6 illustrates an embodiment of the present invention, seen from the side where the second connection point has a second distance C to the pivoting means and where the backrest is in a first angular position relative to the seat frame,

FIG. 7 illustrates an embodiment of the present invention, seen from the side where the second connection point has a second distance C to the pivoting means and where the backrest is in a second angular position relative to the seat frame,

FIG. 8 illustrates an embodiment of the present invention and the visual indicator for indicating actual distance C.

### DETAILED DESCRIPTION OF THE INVENTION

In the explanation of the figures, identical or corresponding elements will be provided with the same designations in different figures. Therefore, no explanation of all details will be given in connection with each single figure/embodiment.

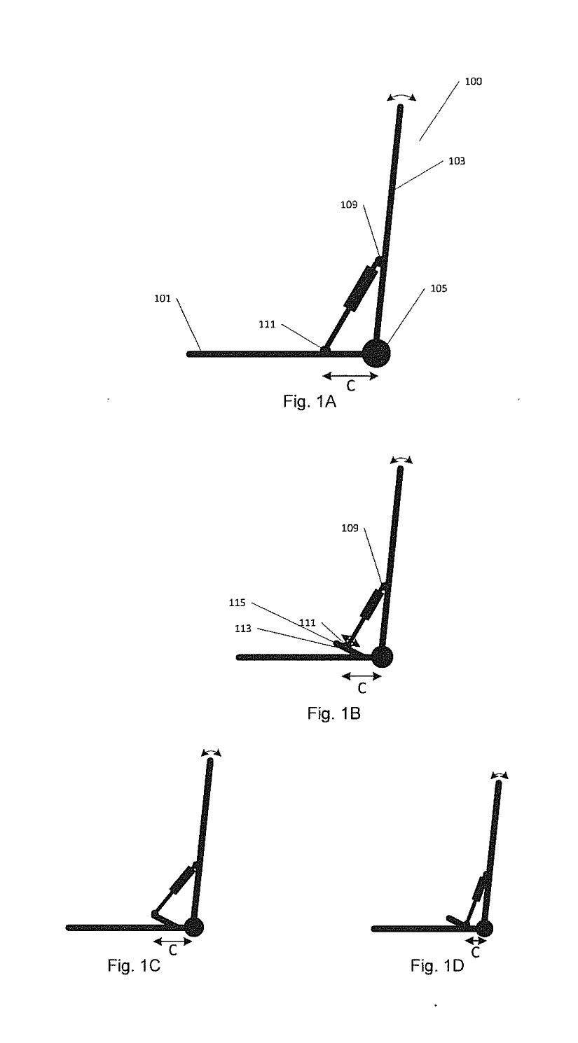

FIG. 1 A-D illustrate the principles of the present invention. In FIG. 1 A a seat 100 for attachment to a wheel chair is illustrated. The seat comprises a seat frame 101 and a backrest 103, wherein the backrest is pivotably connected to the seat frame through pivoting means 105. The seat further comprises spring means 107 connected to the backrest and the seat frame through a first connection point 109 and a second connection point 111 near the seat frame 101, wherein the second connection point 111 and the pivoting means 105 are spaced by the distance C. The spring means could in one embodiment be a gas spring, but alternative spring elements could also be used.

The seat comprises adjustment means (not shown) for varying the distance C between the second connection point 111 and the pivoting means 105.

In FIG. 1 B an embodiment is shown where the distance C can be varied by displacement of the second connection point 111. In this embodiment the second connection point 111 is connected to a guide arm 115. Thereby adjustment means 113 makes the connection point displaceable, whereby the distance C between the second connection point 111 and the pivoting means 105 is adjustable by sliding the second connection 111 point along the guide arm 115. In FIG. 1 C and FIG. 1 D situations are illustrated where the second connection point 111 is in two different positions, whereby the distance C is varied.

By moving the connection point in a different direction than the direction of the spring force it becomes easier to fine tune the distance, since it is not necessary to work against the forces of the spring means. Further by having a guide arm where the connection points are moved along it is easier to control the process, since the guide arm assists.

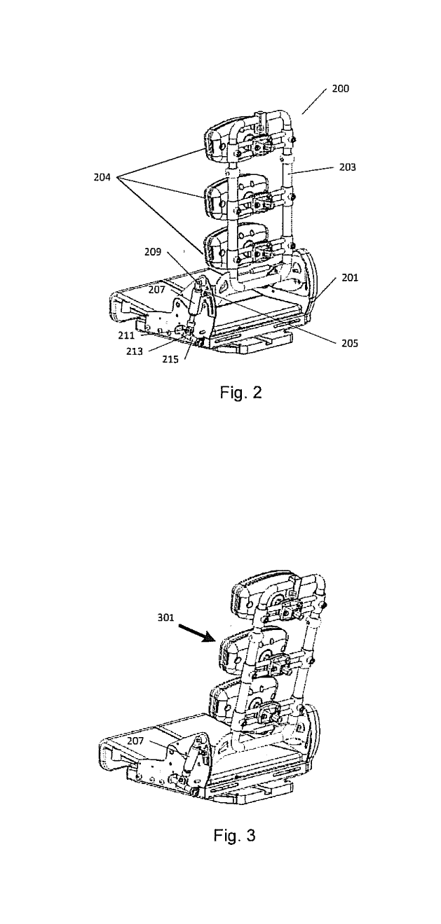

FIG. 2 illustrates an embodiment of the present invention, seen from behind the backrest, being in a first angular position relative to the seat frame. The specific embodiment of the seat 200 comprises a seat frame 201 with a support surface as well as a backrest 203 which comprises a number of back support elements 204. The back rest and the seat frame are pivotably connected in pivoting means 205. The seat further comprises a gas spring 207 connected to the backrest and the seat frame through a first connection point 209 and a second connection point 211.

The seat comprises adjustment means 213 for changing the distance between the second connection points 211 and the pivoting means 205. The adjustment means comprises a guide arm 215 being mounted to the seat frame 201 and the second connection point 211 is slideably connected around said guide arm 215 for sliding along said guide arm in the direction of the guide arm.

Similar spring means and adjustment means are positioned at the opposite side of the seat.

FIG. 3 illustrates the embodiment of the present invention, seen from behind the backrest being in a second angular position relative to the seat frame, in this position the gas spring 207 is forced together because of load (indicated by arrow 301) on the backrest.

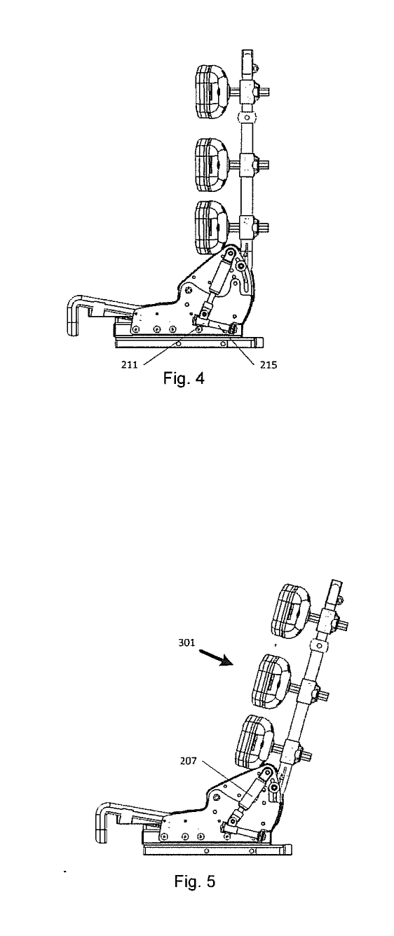

FIG. 4 illustrates an embodiment of the present invention, seen from the side where the second connection point 211 has been moved to one end of the guide arm 215, thereby a first distance between connection points is obtained and thereby one tension of the gas spring is obtained.

FIG. 5 illustrates the embodiment of the present invention, seen from the side being in a second angular position relative to the seat frame, in this position the gas spring 207 is forced together because of load (indicated by arrow 301) on the backrest.

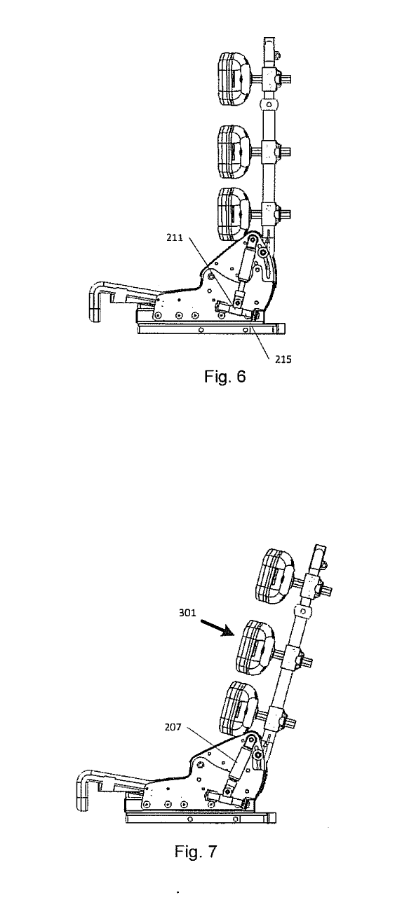

FIG. 6 illustrates an embodiment of the present invention, seen from the side where the second connection point 211 is positioned in the middle of the guide arm 215, thereby a second distance between connection points is obtained and thereby a second tension of the gas spring is obtained.

FIG. 7 illustrates the embodiment of the present invention, seen from the side being in a second angular position relative to the seat frame, in this position the gas spring 207 is forced together because of load (indicated by arrow 301) on the backrest.

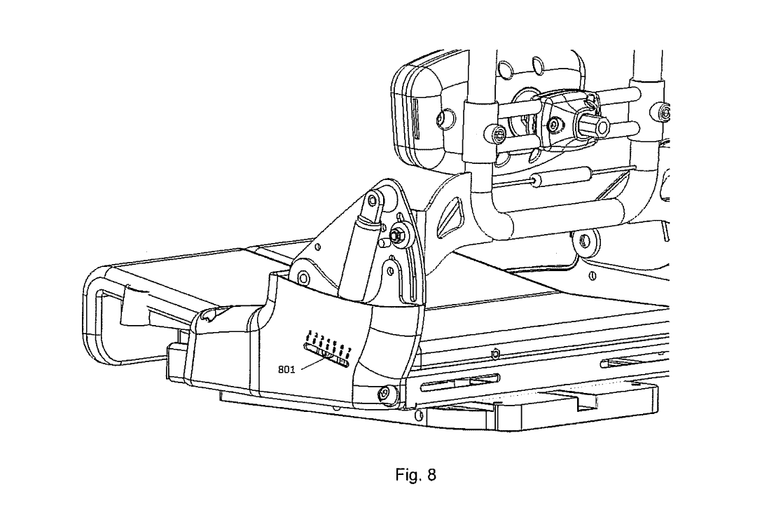

FIG. 8 illustrates an embodiment of the present invention and the visual indicator 810 for indicating actual distance C between said connection points. Here a gap is made and the position of the connection point can be seen through the gap. Different positions indicate different tensions of the gas spring. Positions have been indicated by a visual scale, thereby positions can be referred to for later reference, e.g. for a similar position of a similar adjustment means at the opposite side of the seat.

### References

100, 200—Seat
101, 201—Seat frame
103, 203—Backrest
204—Back support elements
105, 205—Pivoting means
107—Spring means
207—Gas spring
109, 209—first connection point
111, 211—second connection point
113, 213—Adjustment means
115, 215—Guide arm
301—Load on backrest
810—Visual indicator

1. A seat having seat connection mechanism for attachment of the seat to a wheelchair comprising;
a seat frame;
a backrest, wherein the backrest is pivotably connected to the seat frame through a pivoting mechanism, and
a biasing member-connected to the backrest at a first connection point and to a second connection point near the seat frame, wherein the second connection point and the pivoting mechanism are spaced by the distance C, wherein the seat comprises adjustment mechanism adapted for changing the distance C wherein said second connection point is connected to a guide arm and the position of said second connection point and thereby the distance C is adjustable by sliding said second connection point along said guide arm.

2. The seat according to claim 1, wherein said adjustment mechanism are adapted for changing the distance C by displacement of the position of said second connection point.

3. The seat according to claim 1, wherein said guide arm is mounted to the seat frame and said connection point is slideably connected around said guide arm for sliding along said guide arm.

4. The seat according to claim 1, wherein said guide arm is extending in a direction perpendicular to the direction of the biasing member.

5. The seat according to claim 1, wherein the seat comprises a biasing member connected to the backrest and the seat frame and positioned at each side of the seat.

6. The seat according to claim 1, wherein the seat comprises a visual indicator for indicating actual distance C.

7. The seat according to claim 1, wherein the seat comprises locking mechanism for locking the second connection point at predefined positions along the guidearm thereby fixing the distance C.

8. A wheelchair comprising a seat according to claim 1.

9. A method of adjusting the resiliency of a backrest of a seat for a wheelchair, where said seat has seat connection mechanism for attachment of the seat to a wheelchair comprising;
a seat frame,
a backrest wherein the backrest is pivotably connected to the seat frame through a pivoting mechanism, and
a biasing member connected to the backrest at a first connection point and to a second connection point near the seat frame, wherein the second connection point and the pivoting mechanism can be spaced a distance C, where the seat comprises adjustment mechanism adapted for changing the distance C wherein said second connection point is connected to a guide arm and the position of said second connection point and thereby the distance C is adjustable by sliding said second connection point along said guide arm such that the greater the distance C the softer the resulting spring action will be, and the shorter the distance C the firmer the resulting spring action will be.

10. The method according to claim 9, wherein the biasing member is a double acting gas spring member, where said gas spring member may be exchanged for another gas spring member having a different spring characteristic.
